(19) United States
(12) Patent Application Publication
(10) Pub. No.: US 2012/0102475 A1
(43) Pub. Date: Apr. 26, 2012

(54) COMMUNICATION DEVICE AND FIRMWARE PATCHING METHOD THEREOF

(75) Inventors: CHIH-YUAN HUANG, Tu-Cheng (TW); MING-CHIN HO, Tu-Cheng, Taipei Hsien (TW)

(73) Assignee: HON HAI PRECISION INDUSTRY CO., LTD., Tu-Cheng (TW)

(21) Appl. No.: 12/981,459

(22) Filed: Dec. 29, 2010

(30) Foreign Application Priority Data
Oct. 26, 2010 (CN) 201010520280.0

(51) Int. Cl. G06F 9/44

(52) U.S. Cl. 717/168

(57) ABSTRACT

A communication device receives and executes a loosely coupled service agent (LCSA) from an external device as one software process in substitution for a thread of an existing application. The device executes the application as one software process comprising a plurality of threads referred to as the tightly coupled service agents (TCSA), among, which a first TCSA provides a first function, which is substituted by a second function of the LCSA. The device associates data objects of the first TCSA to the LCSA.

### BACKGROUND

1. Technical Field

The disclosure relates to computer techniques, and more particularly to a communication device and firmware patching method thereof.

2. Description of Related Art

A firmware image typically stores boot code and hardware configuration data of a communication device, such as a router, an Ethernet switch, a personal digital assistant (PDA), a cellular telephone, where the functionality and performance of the firmware greatly affects the functionality of the communication device. This is the reason why firmware development and debugging require a lot of software engineering effort.

Software engineers modify firmware to improve functionality, correct bugs, add new features, or meet other market requests of customers. The software engineers regularly release a new firmware version for users to upgrade their device. Each release requires function proofing, but time consuming verification procedures which may prolong response time of designer to firmware bugs. After downloading and installing the new firmware, a communication device needs to restart to activate the new firmware, but restarting an Ethernet switch in an enterprise environment is undesirable.

### BRIEF DESCRIPTION OF THE DRAWINGS

FIG. 1 is a block diagram of an embodiment of customer premises equipment (CPE);

FIG. 2 is a schematic diagram of an exemplary embodiment of a management layer service application program;

FIG. 3 is a schematic diagram of states and state transitions of an exemplary embodiment of a service agent;

FIG. 4 is a schematic diagram showing data objects of service agents;

FIG. 5 is a schematic diagram showing data objects of a system initialization manager (SIM);

FIG. 6 is a flowchart showing operations of the CPE before patching data is received by the CPE;

FIG. 7 is a flowchart showing operations of the CPE after patching data is received by the CPE;

FIG. 8 is a schematic diagram showing data objects associated with another service agent; and

FIG. 9 is a flowchart showing initialization of the CPE after patching data is received by the CPE.

### DETAILED DESCRIPTION

Description of exemplary embodiments of communication device and firmware patching method thereof is given in the following paragraphs which are organized as:

### 1. System Overview

1.1 Exemplary Device

### 2. Exemplary Embodiments of Firmware Patching Methods

2.1 Initialization Dependency Database and Execution Dependency Database

2.2 Original Operations

2.3 Runtime Replacement

2.4 Replacement During System Initiation

### 3. Conclusion

### 1. System Overview

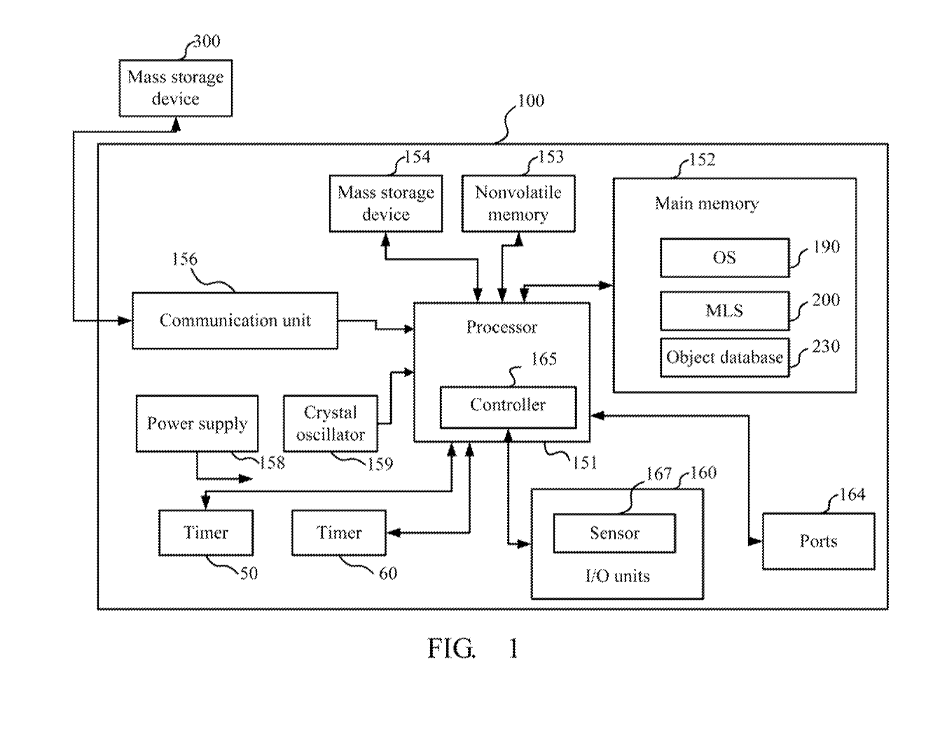

With reference to FIG. 1, a customer premises equipment (CPE) 100 may, for example, comprise an Ethernet switch, router, or modem, such as a cable modem, or a very-high-bit rate digital subscriber line (VDSL) modem. The disclosed customer premises equipment (CPE) 100 can be implemented as a stand-alone device or integrated in various electronic devices, such as a set top box, and a personal computer (PC).

### 1.1 Exemplary Device

In FIG. 1, a processor 151 comprises a central processing unit of the customer premises equipment 100. The processor 151 may comprise various integrated circuits (ICs) for processing data and machine-readable instructions. Connection of the components in the device 100 is shown in FIG. 1 and may comprise serial or parallel transmission buses, or wireless communication channels. A communication unit 156 establishes communication channels through which the device 100 may connect to the Internet. Additionally, the communication unit 156 may establish wired or wireless communication channels through which a computer or a portable device, such as a cell phone, a remote control, or a laptop, may connect and exchange data with the device 100. The communication unit 156 may comprise antennas, base band, and radio frequency (RF) chipsets for wireless local area network (LAN) communication and/or cellular communication such as wideband code division multiple access (W-CDMA) and high speed downlink packet access (HSDPA). Through the established wireless communication channels, the device 100 may serve as a wireless LAN access point through which the portable device connects to the Internet.

The processor 151 may be packaged as a chip or comprise a plurality of chips interconnected through buses. For example, the processor 151 may only comprise a central processing unit (CPU) or a combination of a CPU, a digital signal processor (DSP), and a communication controller chip, such as a chip of the communication unit 156. The communication controller may comprise one or more controllers of wired or wireless communication, such as for cellular, infrared, BLUETOOTH™, or wireless local area network (LAN) communication. The communication controller coordinates communication among components of the device 100 or communication between the device 100 and external devices.

A power supply 158 provides electrical power to components of the device 100. A crystal oscillator 159 provides clock signals to the processor 151 and other components of the device 100. The timers 50 and 60 keep track of predetermined time intervals and may comprise circuits, machine-readable programs, or a combination thereof. Each of the timers 50 and 60 generates signals to give notification of expiration of the predetermined time intervals. Input and output (I/O) units 160 may comprise control buttons, an alphanumeric keypad, a touch panel, a touch screen, and a plurality of light emitting diodes (LEDs). A controller 165 detects operations on the I/O units 160 and transmits signals indicative of the detected operation to the processor 151. The controller 165 also controls operations of the I/O units 160. The processor 151 may control the I/O units 160 through the controller 165. Ports 164 may be used to connect to various computerized interfaces, such as an external computer, or a peripheral device. The ports 164 may comprise physical ports complying with universal serial bus (USB) and IEEE 1394 standards, recommended standard 232 (RS-232) and/or recommended standard 11 (RS-11) defined by Electronics Industries Association (EIA), serial ATA (SATA), and/or high-definition multimedia interface (HDMI).

Nonvolatile memory 153 stores firmware programs including an operating system (OS) 190 and applications executable by the processor 151. The processor 151 may load firmware programs from the nonvolatile memory 153 to the main memory 152 for execution and execute the programs as processes in the main memory 152. The processor 151 stores data in a mass storage device 154. The main memory 152 may comprise a random access memory (RAM), such as static RAM (SRAM) or dynamic RAM (DRAM). The nonvolatile memory 153 may comprise an electrically erasable programmable read-only memory (EEPROM) or a flash memory, such as a NOR flash or a NAND flash.

When the processor 151 completes initialization of the OS, the OS 190 initializes and executes a first one of the applications as a process referred to as management layer services (MLS) 200. The device 100 may obtain patch data for the MLS 200 from wireless signals. The device 100 may receive the wireless signals conveying the patch data, for example, through an antenna, a tuner, and a demodulator. Alternatively, the device 100 may obtain the patch data from an information network, such as the Internet, through a network interface. The patch data comprises at least one loosely coupled service agent (LCSA) in substitution for a tightly coupled service agent (TCSA) of the device 100.

### 2. Exemplary Embodiments of Firmware Patching Methods

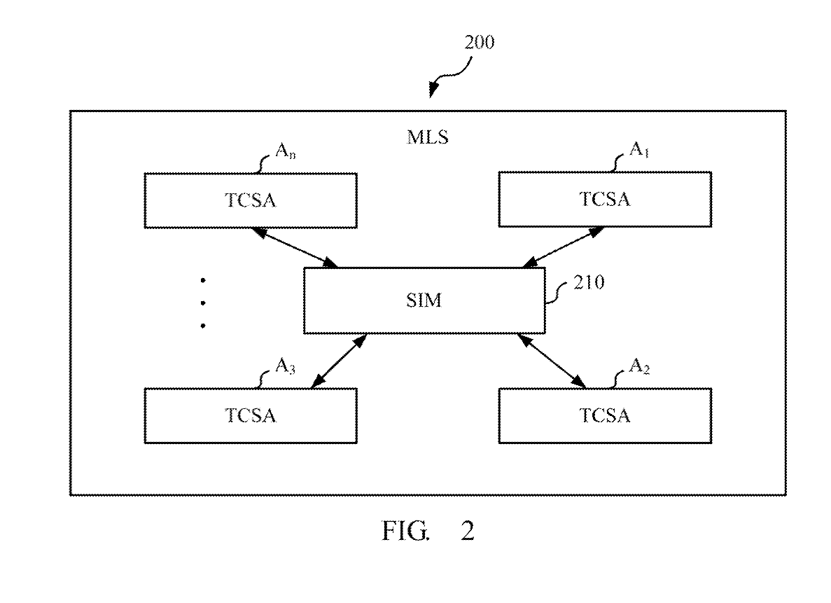

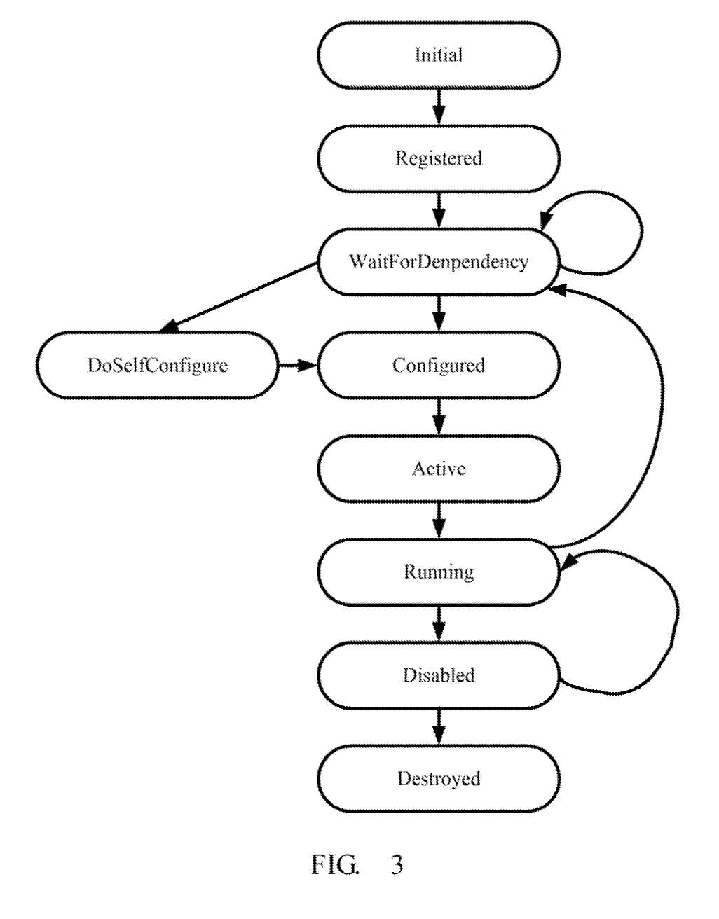

The processor 151 in the communication device 100 executes the MLS 200 as a process. With reference to FIG. 2, the MLS 200 comprises a system initialization manager (SIM) 210 and a plurality of tightly coupled service agents (TCSA) A₁-Aₙ, where n is an integer greater than one. The MLS 200, SIM 210, TCSA A₁-Aₙ and the at least one LCSA may comprise computerized code in the form of one or more programs that are stored in the nonvolatile memory 153. The computerized code includes instructions that are executed by the processor 151 to provide functions for MLS 200, SIM 210, TCSA A₁-Aₙ and the at least one LCSA. Functions provided by the TCSAs A₁-Aₙ executed by the processor 151, for example, may comprise functions of network time protocol (NTP), Ethernet Bridge, firewall, and dynamic host configuration protocol (DHCP). The processor 151 executes each of the SIM 210 and the plurality of TCSAs A₁-Aₙ as a thread of the process of the MLS 200. As shown in FIG. 3, each of the plurality of TCSAs A₁-Aₙ comprises a plurality of states manageable by the SIM 210, including initial, registered, wait-for-dependency, do-self-configure, configured, active, running, disabled, and destroyed. In FIG. 3, each state of a service agent is shown as a node, and a state transition of the service agent is shown as a directed line connecting two nodes. States and state transitions of a loosely coupled service agent (LCSA) is the same as a TCSA which is shown in FIG. 3. An LCSA is a service agent program carried by the patch data and executed by the processor 151 as a process. The SIM 210 controls and manages initialization and execution of the TCSAs A₁-Aₙ and LCSAs. The SIM 210 switches each of TCSAs and LCSAs to one of the plurality of states utilizing a procedure call of the TCSA or LCSA. A service agent, such as a TCSA or a LCSA, in the Initial state registers related data to the SIM 210 and when completes the registering transits from the initial state to the registered state. The service agent then notifies the SIM 210 of dependency relationships associated with the service agent and transits from the registered state to the wait-for-dependency state. The dependency relationships comprise initialization and execution dependency relationships associated with the service agent. The SIM 210 controls initialization of the TCSAs A₁-Aₙ and LCSAs based on the initialization dependency relationships. The SIM 210, for example, initializes a specific service agent in the wait-for-dependency state by triggering the specific service agent to do self-configuration and transit form the wait-for-dependency state to do-self-configure state. When completing the self-configuration, the specific service agent transits form the do-self-configure state to the configured state. The SIM 210 may trigger all TCSAs and LCSAs on which a specific service agent depends to transit to the configured state before triggering the specific service agent to do self-configuration. A service agent transits to the running state when the processor 151 is executing drivers associated with the service agent. After triggering all TCSAs and LCSAs on which a specific service agent depends to transit to the running state, the SIM 210 triggers the specific service agent to transit to the active state. The processor 151 executes the specific service agent in the active state and correspondingly triggers the agent to transit from the active state to the running state. A service transits to the disabled state when the processor 151 is not executing drivers associated with the service agent, and transits to the destroyed state when data associated with the service agent is released from the service agent.

### 2.1 Initialization Dependency Database and Execution Dependency Database

The device 100 utilizes SetParameterValues( )functions and application programming interfaced (API) defined in Technical Report 069 (TR069) to set values in database 230 and inform value change events in database 230 to TCSAs and LCSAs associated with the values.

The main memory 152 stores the MLS 200, data objects, and configuration files of the MLS 200. The data objects comprises an initialization dependency database storing initialization dependency relationships of the TCSAs A₁-Aₙ, and execution dependency database storing execution dependency relationships of the TCSAs The SIM 210 initializes the TCSAs A₁-Aₙ based on the initialization dependency relationships and activates execution of the TCSAs A₁-Aₙ based on the execution dependency relationships.

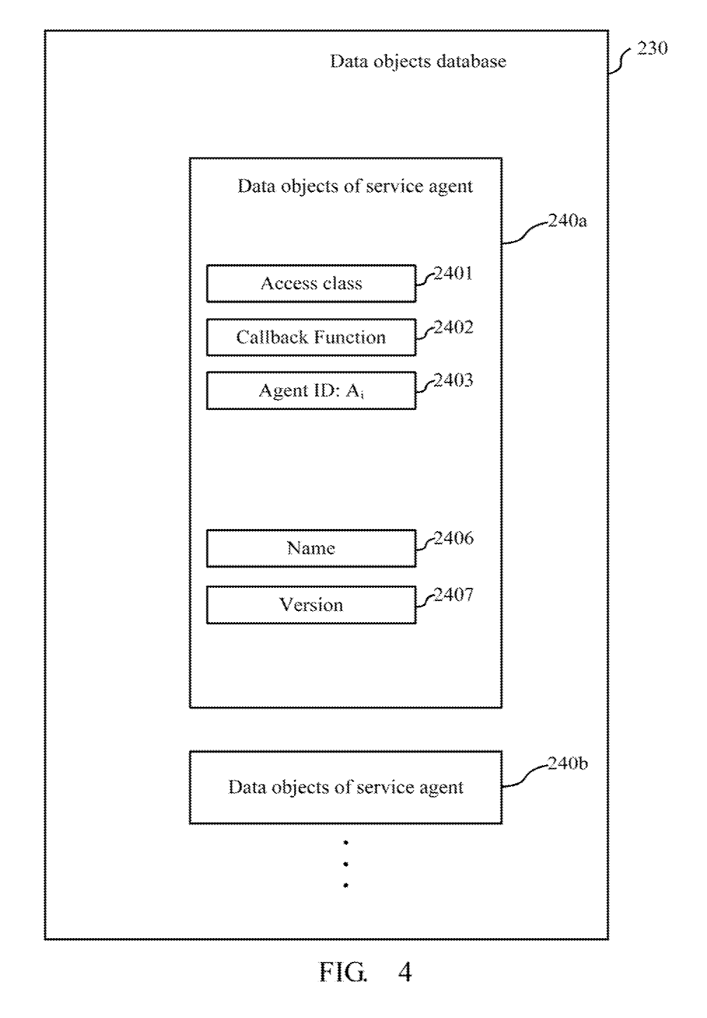

FIG. 4 shows instances 240a and 240b of data objects in the object database 230. Each of the instances 240a and 240b is associated with a service agent and comprises data objects of an access class, callback functions, an agent identification (ID), a name, and version. For example, the instance 240a associated with a TCSA Aᵢ comprises data objects of an access class 2401, callback functions 2402, an agent ID 2403, a name 2406, and version 2407. The variable i is an integer, and 1≦i≦n. The data object of access class 2401 identifies whether the associated service agent is a TCSA or a loosely coupled service agent (LCSA). The data object of callback functions 2402 comprises references to callback functions of the associated TCSA Aᵢ. The data objects of agent ID 2403, name 2406, and version 2407 respectively comprise ID, name, and version of the TCSA Aᵢ associated with the instance 240a.

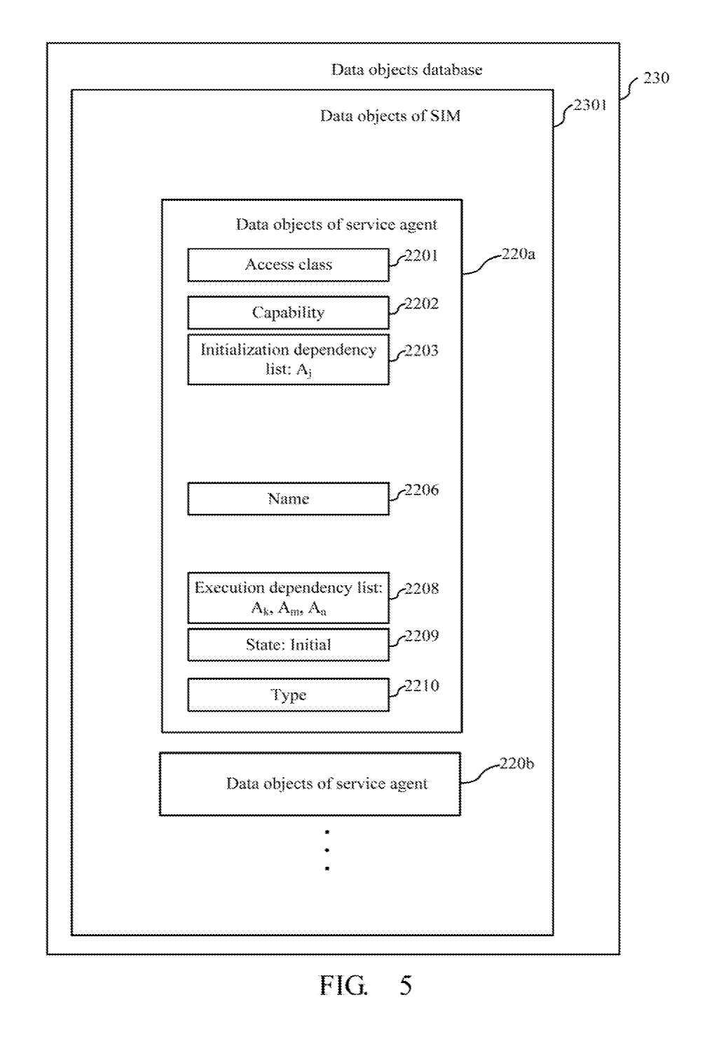

FIG. 5 shows data objects 2301 of the SIM 210 in the object database 230. The data objects 2301 of SIM 210 comprise data objects for controlling service agents, such as instance 220a and 220b of data objects. Each data object instance for controlling service agents comprises data objects of an access class, service agent capability, an initialization dependency list, a name, a parameter key, an execution dependency list, a service agent state, and service agent type. For example, the instance 220a associated with a TCSA Aᵢ comprises data objects of an access class 2201, service agent capability 2202, an initialization dependency list 2203, a name 2206, an execution dependency list 2208, a service agent state 2209, and service agent type 2210. The SIM 210 records capabilities of the TCSA Aᵢ in object 2202, an initialization dependency list and an execution dependency list of the TCSA Aᵢ respectively in objects 2203 and 2208, and state of the TCSA Aᵢ in object 2209. The initialization dependency list and execution dependency list respectively represent initialization dependency relationships and execution dependency relationships associated with the TCSA Aᵢ and comprise IDs of service agents on which the TCSA Aᵢ depends during initialization and execution of the TCSA Aᵢ. The service agents in the dependency lists are referred to as base service agents of the TCSA Aᵢ. In FIG. 5, the initialization dependency list comprises only one base agent Aⱼ, and the execution dependency list comprises base agents Aₖ, Aₘ, and Aₙ.

### 2.2 Original Operations

The MLS 200 directs the processor 151 to perform the following operations.

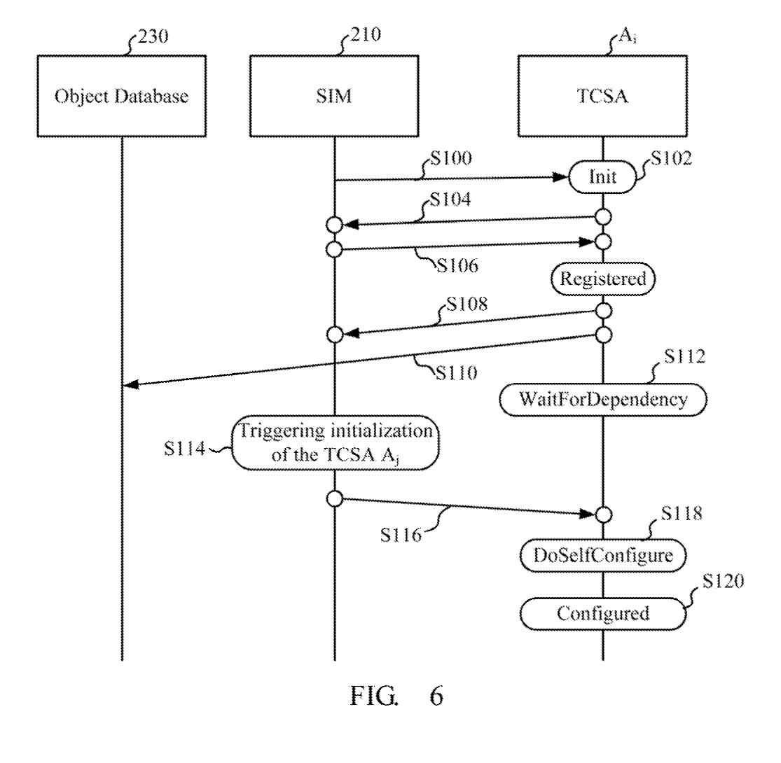

With reference to FIG. 6, the SIM 210 triggers state transition of each of the TCSAs A₁-Aₙ from the Initial state to a next state (step S100). Each of the TCSAs A₁-Aₙ is initially in the Initial state (step S102) and begins registration on the SIM 210 (step S104). Upon completion of registering a TCSA, such as the first agent Aᵢ, the SIM 210 controls the TCSA to transit from the Initial state to the registered state (step S106). The registration of each of the TCSAs A₁-Aₙ on the SIM 210 may comprise registering agent capabilities thereof on the SIM 210. With reference to FIG. 5, one of the registered agent capabilities of the first agent Aᵢ is stored as data object 2202 in data objects 2301 of SIM 210 in database 230. The TCSA Aᵢ is described as an example in the following steps, note that the steps may be applied to each of the TCSAs A₁-Aₙ.

The registered TCSA Aᵢ notifies the SIM 210 of dependency relationships associated with the TCSA Aᵢ (step S108). The dependency relationships associated with the registered TCSA Aᵢ may comprise initialization and execution dependency relationships. The registered TCSA Aᵢ associates with data objects in the object database 230 (step S110) and transits from the registered state to a waiting state referred to as the wait-for-dependency state (step S112). The association in step S110 is referred to as data binding. The data binding in step S110 comprises storing ID of the TCSA Aᵢ in the agent ID object 2403. The SIM 210 triggers initialization of the registered TCSA Aᵢ according to the initialization dependency relationships and execution of the registered TCSA Aᵢ according to the execution dependency relationships (step S114). For example, the initialization dependency relationships in the initialization dependency database comprise a first relationship in the object 2203 stating that the TCSA Aᵢ depends on a TCSA Aⱼ among the TCSAs A₁-Aₙ, which means initialization of the TCSA Aᵢ follows initialization of the TCSA Aⱼ. The variable j is an integer, and 1≦j≦n,j≠i. In the step S114, the SIM 210 orderly triggers initialization of the TCSA Aⱼ and the registered TCSA Aᵢ. In the initialization of the registered TCSA Aⱼ, the SIM 210 controls the TCSA Aⱼ to do self configuration and transit from the wait-for-dependency state to the do-self-configure state. Following completion of the initialization of the TCSA Aⱼ, the SIM 210 triggers (step S116) initialization of the TCSA Aᵢ in which the SIM 210 controls the TCSA Aᵢ to do self configuration and transit from the wait-for-dependency state to the do-self-configure state (step S118). The initialization of each of the TCSAs A₁-Aₙ, for example, may comprise setting up one or more drivers for the function of the TCSA. The TCSA Aᵢ changes states according to FIG. 3.

### 2.3 Runtime Replacement

The communication unit 156 is in communication with an external device 300 and receives a loosely coupled service agent (LCSA) B as a substitution for a first agent Aᵢ from the external device 300. The LCSA B is referred to as patch data of the agent Aᵢ and provides a second function to substitute a first function of the first agent A. For example, each of the first and second functions may comprise a function of NTP, a Ethernet Bridge, a firewall, or DHCP.

The processor 151 executes the LCSA B as another process in substitution to the first agent Aᵢ by disabling the first agent Aᵢ and associating data objects of the first agent Aᵢ to the LCSA B. States and state transitions of an LCSA is the same as a TCSA which is shown in FIG. 3. Thus, the device 100 may receive one or more LCSAs to replace one or more TCSAs.

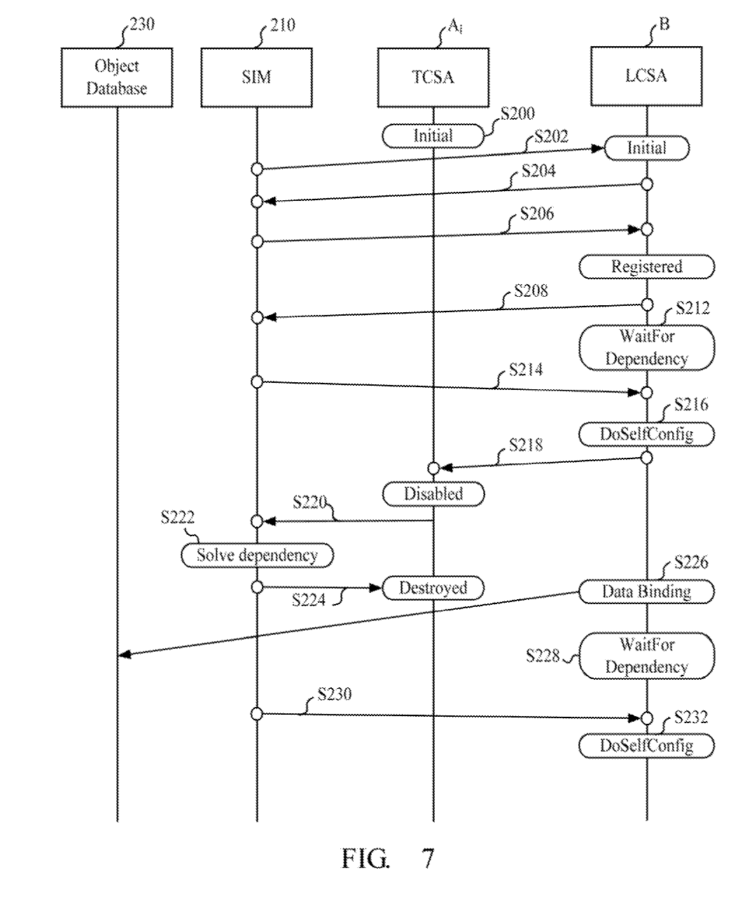

With reference to FIG. 7, the TCSA Aᵢ is initially in a running state (step S200). The SIM 210 triggers state transition of LCSA B from the initial state to a next state (step S202). LCSA B begins registration on the SIM 210 (step S204). The registration of LCSA B on the SIM 210 may comprise registering agent capabilities thereof on the SIM 210. Upon completion of registering the LCSA B, the SIM 210 controls the LCSA B to transit from the initial state to the registered state (step S206).

The registered LCSA B notifies the SIM 210 of dependency relationships associated with the LCSA B (step S208). The dependency relationships associated with the registered LCSA B may comprise initialization and execution dependency relationships. The LCSA B and the notified SIM 210 direct the processor 151 to add dependency relationships associated with the LCSA B to the database 230. The registered LCSA B transits from the registered state to a waiting state referred to as the wait-for-dependency state (step S212). The SIM 210 triggers initialization and execution of the registered TCSA A₁-Aₙ, and the LCSA B according to the initialization dependency relationships and the execution dependency relationships (step S214). For example, the initialization dependency relationships of the LCSA B comprise a second relationship stating that initialization of the LCSA B follows initialization of the TCSA Aⱼ. In the step S214, the SIM 210 triggers initialization of the TCSA Aⱼ prior to initialization of the registered LCSA B. In the initialization of the registered TCSA Aⱼ, the SIM 210 controls the TCSA Aⱼ to do self configuration and transit from the wait-for-dependency state to the do-self-configure state. Following completion of the initialization of the TCSA Aⱼ, the SIM 210 triggers initialization of the LCSA B in which the SIM 210 controls the LCSA B to do self configuration and transit from the wait-for-dependency state to the do-self-configure state (step S216). The initialization of the LCSA B, for example, may comprise setting up one or more drivers for the function of the LCSA B.

The self configuration of LCSA B comprises triggering disablement of the TCSA Aᵢ. For example, the LCSA B requests the TCSA Aᵢ to transit from the running state to the disabled state (step S218). The TCSA Aᵢ notifies the SIM of the state transition to the disabled state (step S220). The SIM responds to the notification by controlling all agents including TSCAs or LCSAs depending on the TCSA Aᵢ to transit to the wait-for-dependency state (step S222). After step S222, the SIM triggers the TCSA Aᵢ to transit to the destroyed state (step S224).

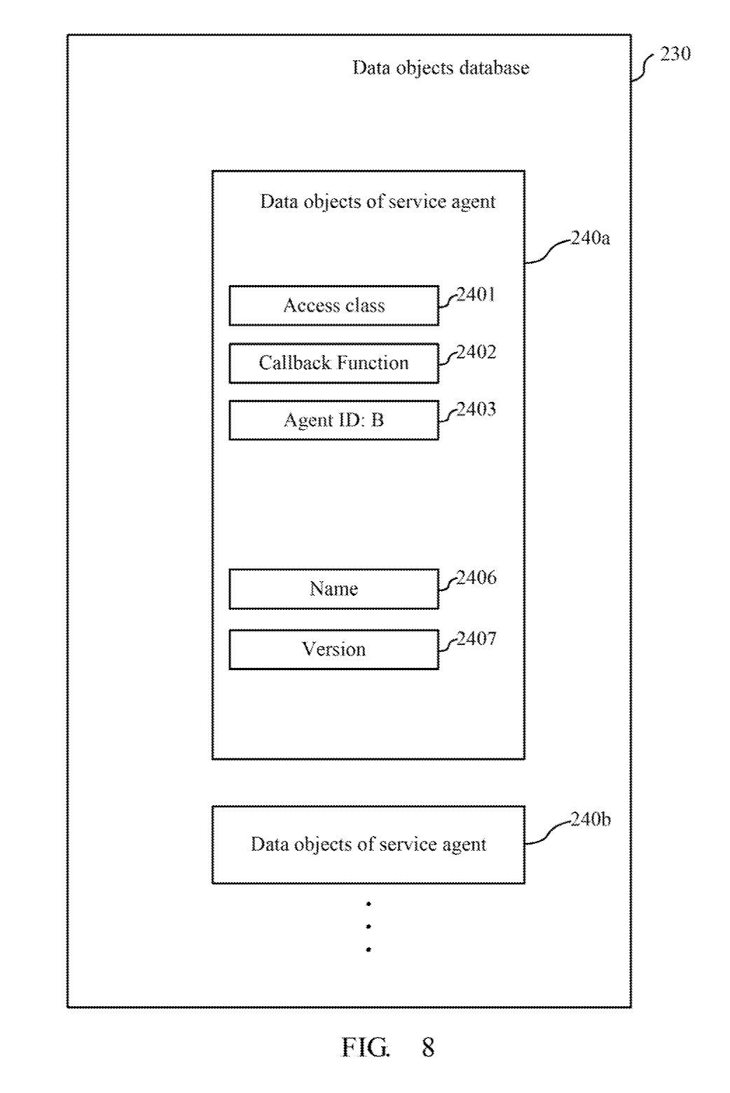

The LCSA B performs data binding with data objects of the TCSA Aᵢ in the object database 230 (step S226) and transits from the do-self-configure state to the wait-for-dependency state (step S228). As shown in FIG. 8, the data binding in step S226 comprises storing ID of the LCSA B in the agent ID object 2403. After completion of step S226, the SIM 210 triggers initialization of the LCSA B in which the SIM 210 controls the LCSA B to do self configuration (step S230) and transit from the wait-for-dependency state to the do-self-configure state (step S232). The initialization of the LCSA B, for example, may comprise setting up one or more drivers for the function of the LCSA B.

In step S208, the LCSA B may add an execution dependency relationship to the database 230, stating that execution of the LCSA B follows execution of one or more TCSAs. The SIM 210 activates execution of the LCSA B in response to execution of the one or more TCSAs based on the added execution dependency relationship.

### 2.4 Replacement During System Initiation

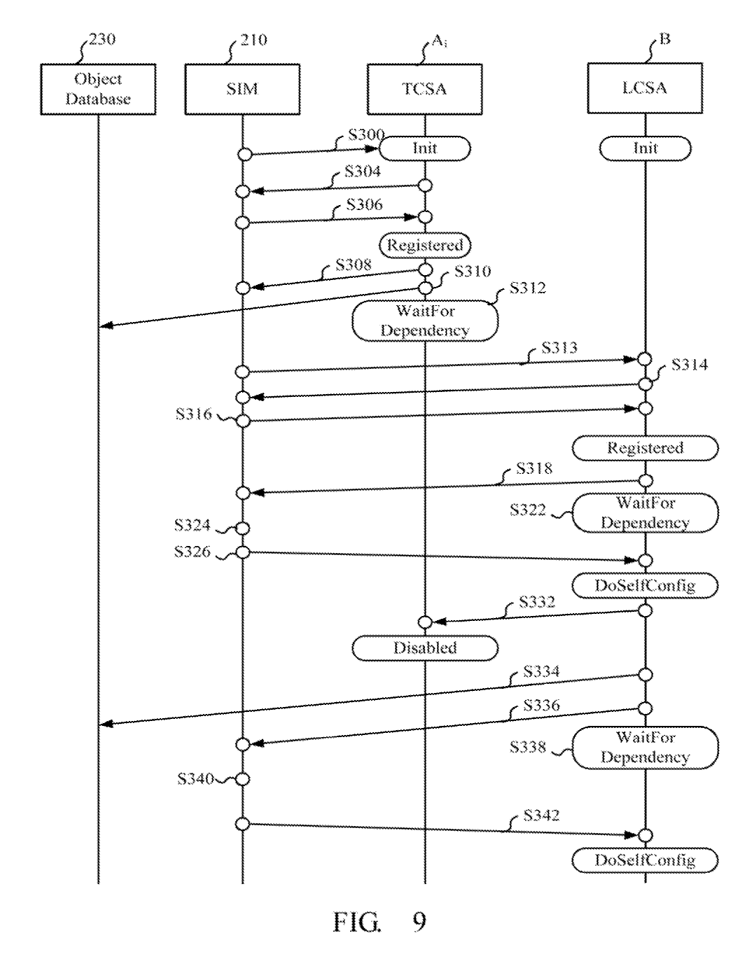

With reference to FIG. 9, the SIM 210 triggers state transition of the TCSA Aᵢ from the Initial state to a next state (step S300). TCSA Aᵢ begins registration on the SIM 210 (step S304). Upon completion of registering the TCSA Aᵢ, the SIM 210 controls the TCSA Aᵢ to transit from the initial state to the registered state (step S306).

The registered TCSA Aᵢ sets up and informs associated dependency relationships thereof to the SIM 210 (step S308). The dependency relationships associated with the registered TCSA Aᵢ may comprise initialization and execution dependency relationships. The registered TCSA Aᵢ triggers data binding with data objects in the object database 230 (step S310) and transits from the registered state to the wait-for-dependency state (step S312).

The SIM 210 triggers state transition of LCSA B from the initial state to a next state (step S313). LCSA B begins registration on the SIM 210 (step S314). Upon completion of registering the LCSA B, the SIM 210 controls the LCSA B to transit from the initial state to the registered state (step S316).

The registered LCSA B sets up and informs associated dependency relationships thereof to the SIM 210 (step S318). The dependency relationships associated with the registered LCSA B may comprise initialization and execution dependency relationships. The initialization dependency relationships associated with the LCSA B states that initialization of the LCSA B is prior to all TCSAs. Step S318 is referred to as first dependency setup. The registered LCSA B transits from the registered state to the wait-for-dependency state (step S322). The SIM 210 triggers initialization of the registered the LCSA B and TCSA A₁-Aₙ according to the initialization dependency relationships of the LCSA B (step S324). In the step S324, the SIM 210 accordingly triggers initialization of the LCSA B prior to initialization of all TCSAs including the TCSA In the initialization of the registered LCSA B, the SIM 210 controls the LCSA B to do self configuration and transit from the wait-for-dependency state to the do-self-configure state (step S326).

The self configuration of LCSA B comprises triggering disablement of the TCSA Aᵢ. For example, the LCSA B requests the TCSA Aᵢ to transit from the running state to the disabled state (step S332). The TCSA Aᵢ transits from the running state to the disabled state and notifies the SIM 210 of the state transition to the disabled state. The SIM triggers the TCSA Aᵢ to transit to the destroyed state.

The LCSA B triggers data binding with data objects of the TCSA Aᵢ in the object database 230 (step S334), informs new dependency relationships thereof to the SIM 210 (step S336), and transits from the do-self-configure state to the wait-for-dependency state (step S338). The new dependency relationships of the LCSA B replace the dependency relationships in the first dependency setup. One of the new dependency relationships of the LCSA B states that initialization of the LCSA B follows initialization of the TCSA Aⱼ. In the step S340, the SIM 210 triggers initialization of the TCSA Aⱼ prior to initialization of the registered LCSA B. After completion of step S340, the SIM 210 triggers initialization of the LCSA B in which the SIM 210 controls the LCSA B to do self configuration (step S342) and transit from the wait-for-dependency state to the do-self-configure state. The initialization of the LCSA B, for example, may comprise setting up one or more drivers for the function of the LCSA B.

### 3. Conclusion

In conclusion, the device 100 executes the MLS 200 as a process and TCSAs as threads of the process and receives an LCSA to replace a faulty TCSA. The LCSA is executed by the device 100 as another process. States of the TCSAs and LCSAs is standardized and managed by the SIM 210 according to dependency relationships of the TCSAs and LCSAs.

It is to be understood, however, that even though numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A communication device, comprising:
a memory operable to store a management layer service operable to be executed by the communication device as a process with a plurality of tightly coupled service agents, wherein each of the plurality of the tightly coupled service agents functions as a thread of the management layer service;
a communication unit operable to be in communication to an external device; and
a processor electrically connected to the memory and the communication unit, operable to execute a firmware patching method comprising:
receiving a loosely coupled service agent as a substitution for a first agent of the plurality of the tightly coupled service agents from the external device, wherein the loosely coupled service agent provides a second function to substitute a first function of the first agent; and
executing the loosely coupled service agent as another process in substitution to the first agent by disabling the first agent and associating data objects of the first agent to the loosely coupled service agent.

2. The communication device as claimed in claim 1, wherein the memory comprises an initialization dependency database operable to store initialization dependency relationships of the plurality of the tightly coupled service agents, the management layer service comprises a thread referred to as system initialization manager operable to manage initialization of the plurality of the tightly coupled service agents based on the initialization dependency relationships.

3. The communication device as claimed in claim 2, wherein the dependency relationships comprise a first relationship stating that initialization of the first agent follows initialization of a second agent of the plurality of the tightly coupled service agents, the patching method further comprising:
registering the loosely coupled service agent on the system initialization manager after the communication unit receives the loosely coupled service agent from the external device;
directing the processor by the loosely coupled service agent to add a second dependency relationship to the dependency relationships, the second relationship states that initialization of the loosely coupled service agent follows initialization of the second agent;
directing the processor by the system initialization manager to activate initialization of the loosely coupled service agents after initialization of the second agent based on the second dependency relationship; and
triggering the first agent to be disabled by the loosely coupled service agent.

4. The communication device as claimed in claim 3, wherein the patching method further comprises:
adding by the loosely coupled service agent a third relationship to the dependency relationships during initialization of the communication device, the third relationship states that initialization of the loosely coupled service agent precedes initialization of the plurality of the tightly coupled service agents;
triggering by the loosely coupled service agent the first agent to be disabled; and
utilizing the second relationship to replace the third relationship during initialization of the loosely coupled service agent according to the third relationship.

5. The communication device as claimed in claim 3, wherein the first agent comprises a plurality of states, and the system initialization manager switches the first agent to one of the plurality of states utilizing a procedure call of the first agent.

6. The communication device as claimed in claim 5, wherein the memory comprises an execution dependency database operable to store execution dependency relationships of the plurality of the tightly coupled service agents, and the system initialization manager activates execution of the plurality of the tightly coupled service agents based on the execution dependency relationships.

7. The communication device as claimed in claim 6, wherein the execution dependency relationships comprise a fourth relationship stating that execution of the first agent follows execution of a third agent of the plurality of the tightly coupled service agents, the patching method further comprises:
registering the loosely coupled service agent on the system initialization manager after the communication unit receives the loosely coupled service agent;
adding by the loosely coupled service agent a fifth relationship to the execution dependency relationships, the fifth relationship states that execution of the loosely coupled service agent follows execution of the third agent; and
activating by the system initialization manager execution of the loosely coupled service agents in response to execution of the third agent based on the fifth dependency relationship.

8. A firmware patching method, executable by a communication device comprising a memory, a communication unit, and a processor, wherein the memory stores a management layer service operable to be executed by the communication device as a process with a plurality of tightly coupled service agents, wherein each of the plurality of the tightly coupled service agents functions as a thread of the management layer service, comprising:
receiving by the communication unit from an external device a loosely coupled service agent from the external device, wherein the loosely coupled service agent provides a second function to substitute a first function of a first agent of the plurality of the tightly coupled service agents; and
execution of the loosely coupled service agent as another process by the processor to replace the first agent by disabling the first agent and associating data objects of the first agent to the loosely coupled service agent.

9. The method as claimed in claim 8, wherein the memory comprises an initialization dependency database operable to store initialization dependency relationships of the plurality of the tightly coupled service agents, and the management layer service comprises a thread referred to as system initialization manager, further comprising:
initializing the plurality of the tightly coupled service agents by the system initialization manager based on the initialization dependency relationships.

10. The method as claimed in claim 9, wherein the dependency relationships comprise a first relationship stating that initialization of the first agent follows initialization of a second agent of the plurality of the tightly coupled service agents, further comprising:
registering the loosely coupled service agent on the system initialization manager after the reception of the loosely coupled service agent from the external device;
adding a second dependency relationship to the dependency relationships under direction of the loosely coupled service agent, wherein the second relationship states that initialization of the loosely coupled service agent follows initialization of the second agent;
activating initialization of the loosely coupled service agents after initialization of the second agent based on the second dependency relationship; and
disabling the first agent by the loosely coupled service agent.
